(19) United States
(12) Patent Application Publication
(10) Pub. No.: US 2007/0256568 A1
(43) Pub. Date: Nov. 8, 2007

(54) Wine Decanting Device

(76) Inventors: Peter Joseph Nudi, Santa Rosa, CA (US); Thomas Scott Hassur, Windsor, CA (US)

Correspondence Address: EDWARD S. SHERMAN, ESQ., 3554 ROUND BARN BLVD., SUITE 303, SANTA ROSA, CA, 95403, US

(21) Appl. No.: 11/741,625

(22) Filed: Apr. 27, 2007

Related U.S. Application Data
(60) Provisional application No. 60/746,294, filed on May 3, 2006.

(51) Int. Cl. B67D 1/00

(52) U.S. Cl. 99/275

(57) ABSTRACT

A device for decanting wine provides optimum aeration to readily measured minimum quantities by first causing the wine poured into the device to form a stream. The stream is then spread laterally over a convex shape before it is again collected. In various embodiments, the wine is collected by an internal funnel like structure within the device, being again spread over another convex surface. The multiple pairs of convex surfaces and associated collecting funnels are preferably housed in a generally tubular enclosure that terminates in a final spout that delivers wine to a storage flask type decanting vessel or wine glass.

### CROSS REFERENCE TO RELATED APPLICATIONS

The present application claims priority to the U.S. Provisional Patent Application entitled “Wine Decanting Device” filed on May 3, 2006 and assigned application Ser. No. 60/746,294, which is incorporated herein by reference.

### BACKGROUND OF INVENTION

The present invention relates to a method and device for pouring and decanting wine and the aeration of grape must or fermenting grape must.

Wine is typically decanted from the bottle used for storage and aging to accomplish at least one of separating sediment deposited during aging from the wine and/or allowing the wine to “breath” before serving. Allowing wine to “breath” is generally understood to involve a slight but important interaction of oxygen with chemical compounds in the wine that improve the bouquet and/or flavor of the wine. Full-bodied red wines are well known to especially benefit from decanting. It is usually necessary to wait for sometimes upward of an hour for a decanted wine to achieve the benefits of decanting. Moreover, it is not a simple matter to predict when even the same wine will have reached the optimum benefit, as not only are wines very different form each other, but wines from a single lot will change in breathing characteristics as they age.

However, it is not always practical to decant wine. Wine service by the glass is more common in restaurants as well as by the consumer, when the do not intend to drink the entire bottle at one sitting or meal.

It is therefore a first object of the present invention to provide an improved method of decanting wine that results in an immediate olfactory and flavor improvement, yet that can be practiced repeated as wine is served by the glass, such as at a tasting bar or in a restaurant.

### SUMMARY OF INVENTION

The inventors have discovered a process of decanting wine that is convenient for achieving the olfactory and flavor benefits of allowing wine to breath without decanting an entire bottle.

Moreover, it has been discovered that the inventive process and an associated device result in a far superior enhancement to the olfactory and flavor of wines than is achieved by decanting.

The inventive and novel process involves first pouring wine into a first funnel, the causing the wine exiting the first funnel as a stream to spread laterally over a preferably convex shape. The wine that spills over the edges of the convex shape is collected. Other aspects of the invention involve repeating the fundamental process multiple times as desired to immediate achieve the optimum level of improvement.

Other aspects of the invention involve providing an apparatus for the above process that comprises a fluid receiving upper portion having a lower opening with a smaller diameter than the fluid receiving opening. Disposed below the bottom of the lower opening is at least one preferably convex surface to laterally spread the wine as it flows downward. Surrounding the edges of this convex surface is at least one funnel disposed to collect the liquid as it flows downward off the edges of the convex surface. The fluid receiving upper portion, convex surface and funnel are connected by an enclosing wall that extends downward from the periphery of the fluid receiving upper portion.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-sectional elevation of a first embodiment of the invention.

FIG. 2 is a cross-sectional elevation of a second embodiment of the invention showing the path of wine as it flows downward.

FIG. 3 illustrates another embodiment of the invention in which the device in FIG. 2 is inverted to rest on a surface along with a receiving flask.

FIG. 4 is a perspective view of another and preferred embodiment of the invention.

FIG. 5 is a top plan view of the embodiment in FIG. 4.

FIG. 6 is a bottom plan view of the embodiment in FIG. 4.

FIG. 7 is a first elevation of the embodiment in FIG. 4.

FIG. 8 is an elevation of the embodiment of FIG. 4 taken orthogonal to the elevation shown in FIG. 7.

FIG. 9 is a cross-sectional elevation of another embodiment of the invention.

FIG. 10 is a cross-sectional elevation of another embodiment of the invention.

FIG. 11 is a cross-sectional elevation of another embodiment of the invention.

FIG. 12 is a cross-sectional elevation of another embodiment of the invention.

FIG. 13 is a cross-sectional elevation of another embodiment of the invention.

FIG. 14 is a cross-sectional elevation of another embodiment of the invention.

FIG. 15 is a cross-sectional elevation of another embodiment of the invention.

FIG. 16A-C illustrate another embodiment of the invention in which the device comprises multiple components that can be stacked to provide the operative state and capable of being disabled for cleaning and storage.

FIG. 17 is a cross-sectional elevation of another embodiment of the invention in which the device comprises multiple components having features of the embodiments of FIG. 11 that can be stacked to provide the operative state and disabled for cleaning and storage.

FIG. 18 is a cross-sectional elevation of another embodiment of the invention in which the device comprises multiple components having features of the embodiments of FIG. 16 that can be stacked to provide the operative state and disabled for cleaning and storage.

FIG. 19 is a cross-sectional elevation of another embodiment of the invention in which the embodiments of FIG. 17 are stacked for delivery of wine to a mating serving receptacle.

FIG. 20 is a cross-sectional elevation of another embodiment of the invention in which different embodiments of separate cylindrical chambers are stacked in an alternating configuration for delivery of wine to a mating serving receptacle.

FIG. 21 is a cross-sectional elevation of another embodiment of the invention with a single aerating flow chamber with a vertical extending dispersing surface.

### DETAILED DESCRIPTION

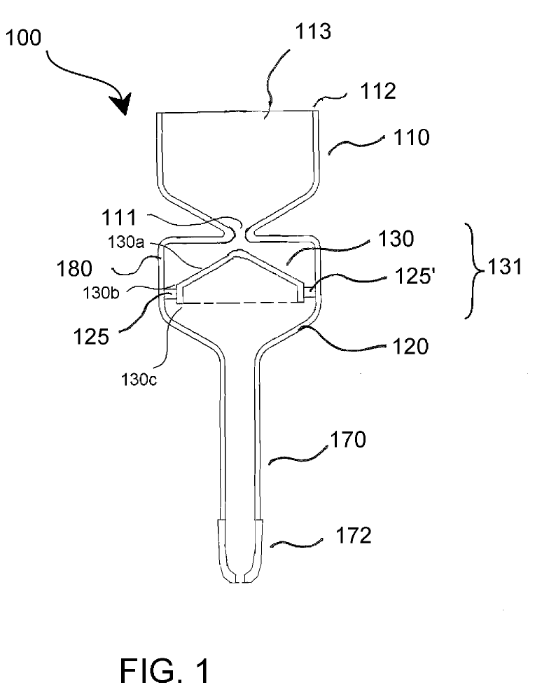

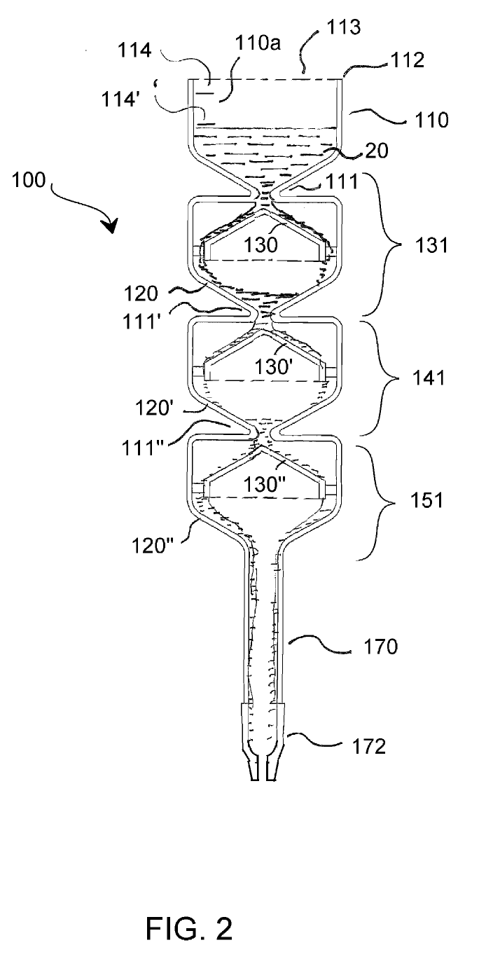

Referring to FIGS. 1 through 2, wherein like reference numerals refer to like components in the various views, there is illustrated therein a new and improved wine decanting device, generally denominated 100 herein.

In accordance with the present invention, FIG. 1 illustrates one embodiment 100 of a wine decanting device for performing one or more times the process described in the above summary. Device 100 is preferably circularly symmetric like a tube such that all elevational views and sections will be essentially the same. The device 100 deploys one or more aerating flow chambers 131, such that device 100 comprises a fluid receiving upper portion 110 having a lower opening 111 with a smaller diameter than the fluid receiving opening 113 that extends to the rim 112. Disposed below the bottom of the lower opening 111 is at least one disperser 130, which is preferably a convex surface, to aerate the wine by forming the stream it receives into a thin radial spreading film layer as it flows downward. Surrounding the edges of this disperser 130 is at least one funnel portion 120 disposed to collect the liquid as it flows downward off the edges 130a of said convex surface. In this embodiment the dispersing surface 130 has an upper conical portion 130a and lower vertically descending skirt 130b, terminating in lower rim 130c.

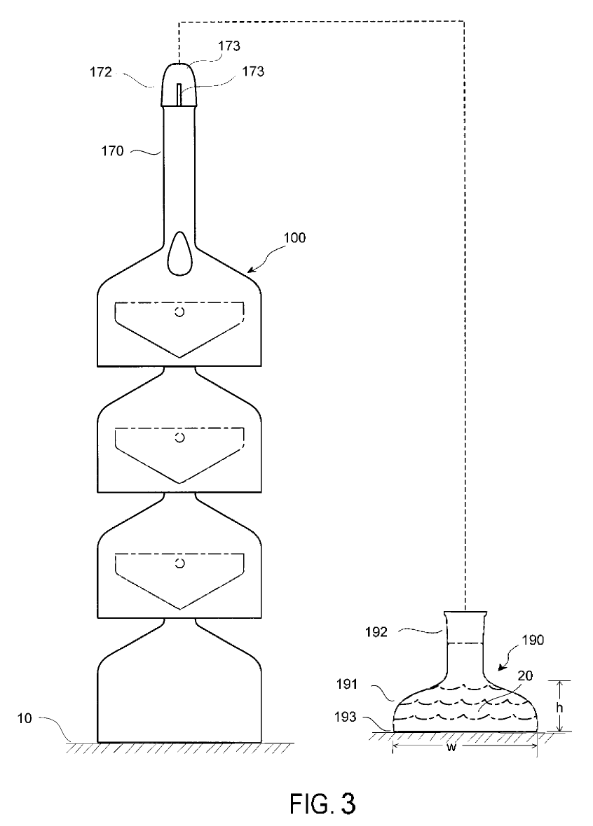

Spacers 125 and 125″ connect two or more points on the periphery about skirt portion 130b to the inner surface of aerating flow chamber 131. Aerating flow chamber 131 comprises the bottom portion of lower opening 111, funnel section 120 and preferably concave dispersing surface 130. The fluid receiving upper portion 110, at least one convex surface 130 and at least one funnel 120 are connected by an enclosing wall 180 that extends downward from rim 112 at the periphery of the opening 130 in the fluid receiving upper portion 110. As shown in this preferred but non-limiting embodiment the enclosing wall 180 may be a continuation of the exterior of chamber 131. In the embodiment of FIG. 1, the wine exits device 100 via neck 170. Neck 170 extends downward from the end of the funnel portion 130 of aerating chamber 131. In the preferred version of this embodiment illustrated herein, neck 170 terminates in a truncated conical fitted section 172 that may accommodate a matching fitting in a liquid receiving vessel 190 that is shown and described further with respect to FIG. 3. Like most fine serving ware for wine, device 100 in the most preferred embodiments is fabricated from glass so that the decanting process is easily observed. In such a case, if sediment does travel from the bottle of the bottle to the device 100, it will be more readily visible on convex surface 120 as it deflects or distorts the stream of wine over the surface.

FIG. 2 illustrates another embodiment with multiple aerating flow chambers such that there is in effect a cascading flow from one aerating flow chamber to the next. Thus, first the wine spreads as thin film over a surface in the first chamber, is collected in the funnel portion such that it can then be dispensed to cascade into the next aerating flow chamber where the process is repeated until the wine exits the device. The device 100 also comprises a fluid receiving upper portion 110 having a lower opening 111 with a smaller diameter than the fluid receiving opening 113. The lower opening 111 is also preferably the end of a funnel shaped wall leading to upper chamber 131. Upper chamber 131 also includes at least one convex surface 120 to laterally spread the liquid wine as a radial film layer as it flows downward. Surrounding the edges 120a of this convex surface is at least one funnel shaped surface 130 disposed to collect the liquid as it flows downward off the edge or lower rim 130c of the dispersing surface 130 such that it exits through a lower opening 111′ between upper chamber 131 and middle chamber 141. Thus, wine will flow over the dispersing surface 130 before it enters middle chamber 141.

Middle chamber 141 also includes at least one preferably convex dispersing surface 130′ to laterally spread the liquid wine as a radial film layer as it flows downward. Surrounding the edges of this convex surface 130′ is at least one funnel shaped wall 120′ is disposed to collect the liquid as it flows downward off the edges 130c of the dispersing surface 130. The funnel shaped wall 120′ again collects and directs the wine such that it exits through a lower opening 111″ between middle chamber 141 and the lower chamber 151.

Accordingly, as the wine 20 then flows into lower chamber 151 via opening 111″ it again encounters another convex surface 130″ that laterally spreads the wine as a radial film layer as it flows downward. Surrounding the edges of this convex surface 130″ is again a funnel shaped wall 120″ disposed to collect the liquid as it flows downward off the edges 130c of the dispersing surface 120 such that it can finally exits device 100. In this example, wine exits device 100 by entering and flowing through neck region 170, which includes in more preferred embodiment a truncated conical fitted section 172.

While the dispersing surface 130 in the various embodiments is preferably convex, is may also be flat or a tilted planar surface, as well as a porous surface for dispersing the wine over a large area before recollection and concentration in the funneling portion 120. Further, non-limiting examples of convex dispersing surfaces are pyramids, cones and dome, the latter of which can have an elliptical, spherical or compound curvature, and the like.

Not wishing to be bound by theory, it is believed that the combined and repeated separation of the wine into a flowing film over the convex surface, with repeated recollection provides a beneficial form of aeration or breathing to wine by entrapping or absorbing oxygen from the surrounding air. This seems to occur in a manner that is also gentle in not bruising the wine and stripping important volatile olfactory substances that contribute greatly to the nose, taste and fullness. The effect, if not actually improving the wine over conventional decanting processes, has at least the benefit of being very rapid and suitable to aerate a single serving portion, rather than entire bottle.

The path of wine 20 as it flows downward from 110 to 170 is shown in FIG. 2 to further illustrate another beneficial aspect of the devices design with respect to pouring measured servings of wine, such as a tasting bar or for wine by the glass service at a restaurant, bar or café. Specifically, in other preferred embodiments, the sidewalls 110a of fluid receiving upper portion 110 include vertical pouring marks 114 and 114′. As the flow constricting opening 111 in each funnel portion 120 limits the rate at which wine 20 poured into fluid receiving upper portion 110 can escape into each successive aerating flow chamber, the server can quickly pour up to vertical pouring mark 114 or 114′ before a major portion of the wine has exited the device 100 via neck 170. Thus, vertical pouring mark 114 or 114′ represent different measured servings of wine that are controlled by the limited flow rate of wine through device 100. Ultimately, the serving of wine 20 measured by pouring to mark 114 or 114′ eventually flows downward through each chamber 131, 141 and 151 such that a glass or another receiving vessel will be filled with the desired unit serving.

It should be appreciated that the size of the fluid receiving upper portion 110 can be varied to be of a different scale and even shape than chamber 131, 141 and 151, as may be preferred to accommodate a larger or smaller quantity of wine. However, it should be understood that a wide range of device sizes and shapes could be deployed to successfully decant an entire bottle of wine by simply avoiding pouring wine 20 into fluid receiving upper portion 110 faster than the rate that the wine exits neck 170. Further, it should be appreciated that the first opening 111 may have a small diameter, while other openings between aerating flow chamber may have a larger diameter.

It has been discovered by taste tests described below that multiple aerating flow chambers 131, 141 and 151 in device 100 of FIG. 2 more preferably aerate the wine in each pass over the convex surfaces 120, 120′ and 120″. While a comparable aeration is achievable using the device 100 shown in FIG. 1 multiple times, having the three chambers that combine a preferably convex dispersing surface and a collaborative collecting funnel is far simpler and faster for a server that must accommodate a larger number of clients.

In addition to the devices 100 of FIG. 1 providing an the immediate improvement in quality, the multiple cascade device 100 of FIG. 2 can provides uniform aeration of any volume of wine when multiple passes through the device of FIG. 1 are desired. Further, like the device 100 in FIG. 1, the devise in FIG. 2 facilitates the aeration and breathing of a serving size portion of wine.

FIG. 3 illustrates another embodiment that includes a liquid receiving vessel 190. Receiving vessel 190 has a wide resting base 193 at the bottom of intermediate fluid collecting portion 191. The wide base 193 aids in supporting the taller device 100 in FIG. 2 when fitting male fitting 172 on neck 170 is inserted into the mating female fitting 192 at the top of flask 190. The width, w, of base 193 is preferably at least the same, and more preferably larger than the height, H, of vessel 190 from bottom 193 to the bottom portion of female fitting 192. Most preferably, the mating contact surfaces on male fitting 172 and female fitting 192 have a ground glass finish to facilitate removal after insertion.

It should be appreciated that as shown in FIG. 3, the device 100 in addition to being inserted into vessel 190 by following the dashed line can also rest on a table or other lateral surface 10 on rim 113 when the wine in flask 190 is poured into serving glasses or other another vessel.

Thus, flask 190 may be large to store an entire bottle of wine that is decanted, or small, say for collecting a single glass serving of wine or merely catching drips from device 100 after it is used to directly direct wine into serving glasses or other another vessel.

It should be further appreciated that the device and method of use disclosed herein provide the benefit of avoiding the need to decanting an entire bottle when smaller portions are desired. It further provides the benefit of providing an optimum aeration of the wine minimizing the time a decanted bottle needs to breathe.

It should also be appreciated that device 100 of either FIG. 1 or FIG. 2 while preferably being an integrated glass assembly, can also be fabricated by assembled by stacking interlocking components, as will be described with respect to additional embodiments. Such stacked components can be permanently attached or fused together in the case of glass, or be intended to be de-interlocking for storage and cleaning. Further, it can be fabricating by first stacking individual glass components before welding or fusing them together to form an integrated device 100 of FIGS. 1 and 2.

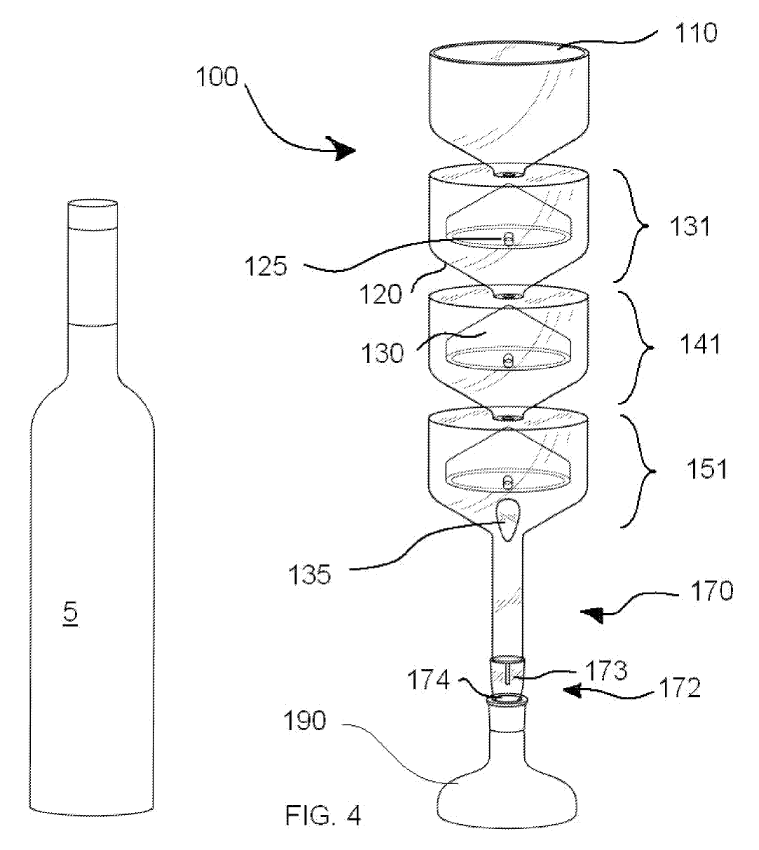

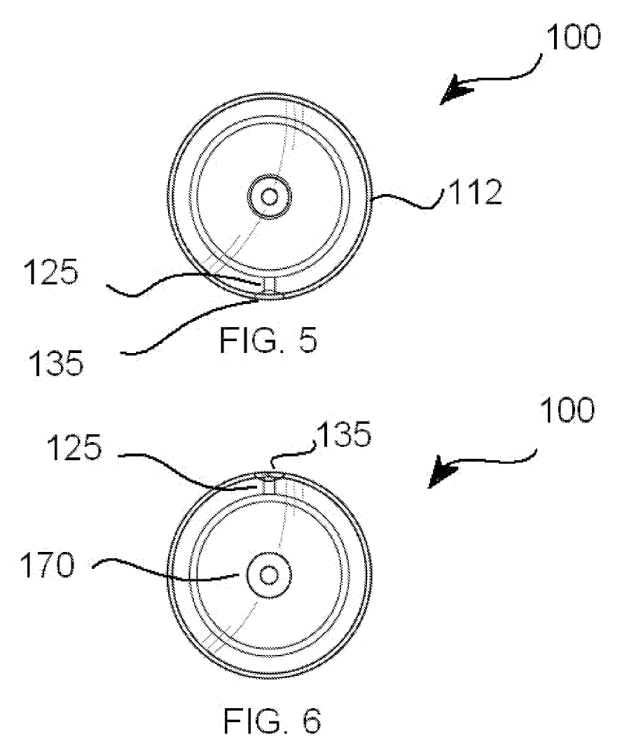

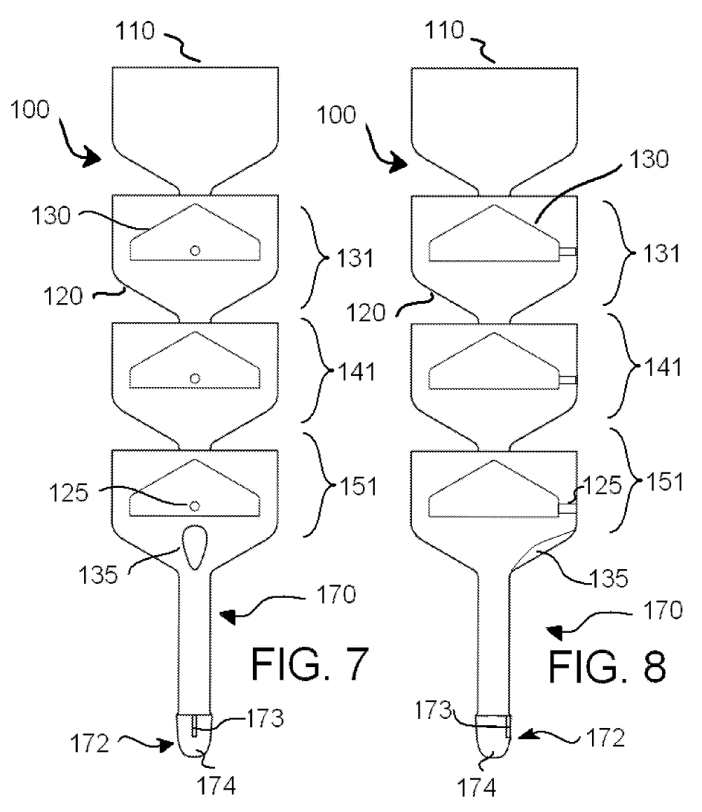

FIG. 4-8 shows more preferred embodiment. A typical 750 ml wine bottle 5 is shown in FIG. 4 so that the scale of device 100 is better appreciated. It should be apparent from these figures that only a single spacer 125 is used to support each disperser 130. Funnel portion 120″ is dimpled at elongated depression 135 to provide an air vent when the neck 170 of device 100 is inserted into a larger wide necked decanter to allow air to escape Similarly, the truncated conical fitted section 172 has a longitudinal external slit 173 to vent air when the mating flask 190 is filled. Further, the truncated conical fitted section 172 has an internal narrowing taper 174 to better direct the wine as a stream into flask 190 or any other receiving vessel, such as a wine glass, carafe or larger decanter.

For single serving use it is desirable that the wine can be filled to the level of the fill marks before a significant portion escapes into the lower aerating flow chambers. This is achieved by restricting the opening 111 to a diameter less than about 7 mm, and more preferably less than about of 5 mm. In device 100, the funnel portion 120 preferably has an upper diameter of about 6 cm, while disperser 130 has a diameter of about 5 cm. The dispenser 130 cone portion 130a has a height of about 1.5 cm and the height of the descending vertical portion 130b that terminates at lower rim 130c is about 1.5 cm. Thus, with these preferred dimensions a serving portion of wine, filled to about a 3 cm height in the receiver (represents a volume of about 90 ml or 3 U.S. fluid oz.) completes the aeration process in 10-12 seconds cascade into the flask 190 or another receiver vessel

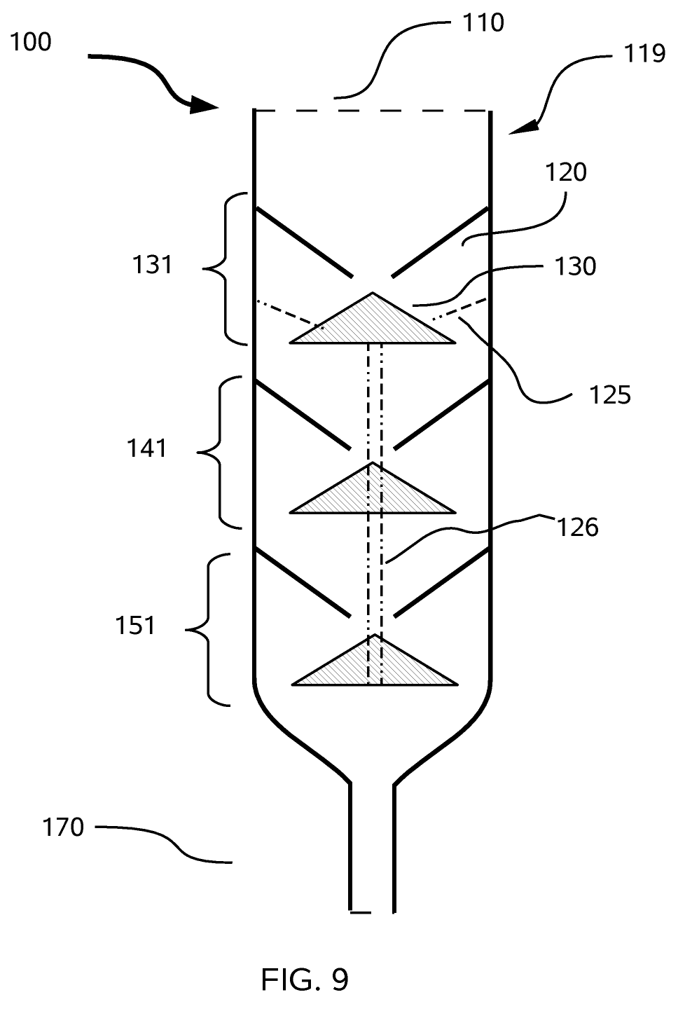

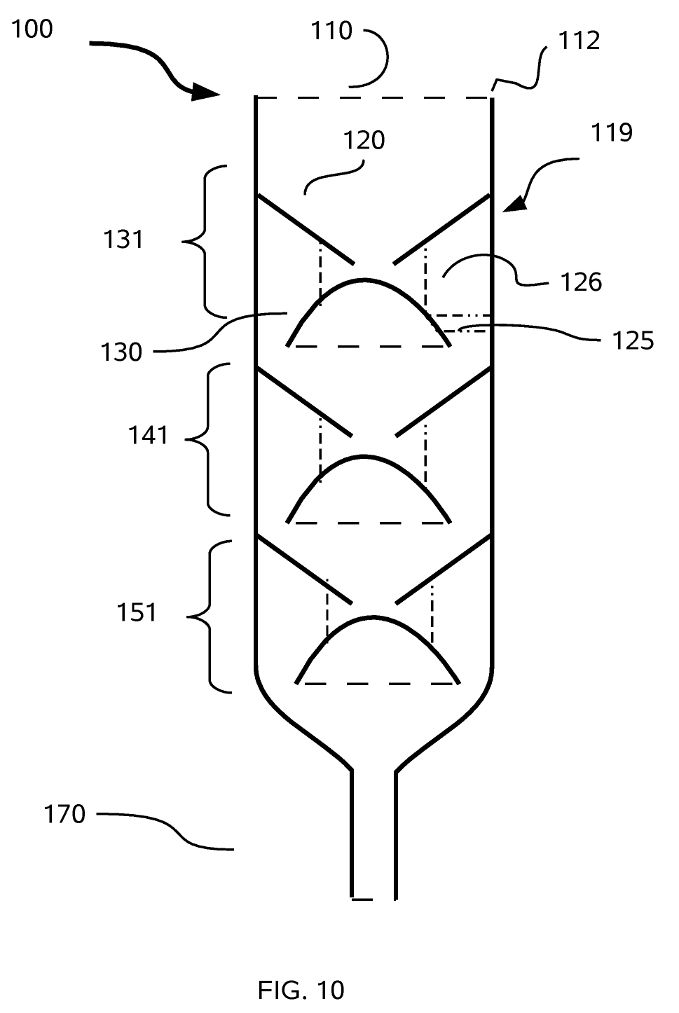

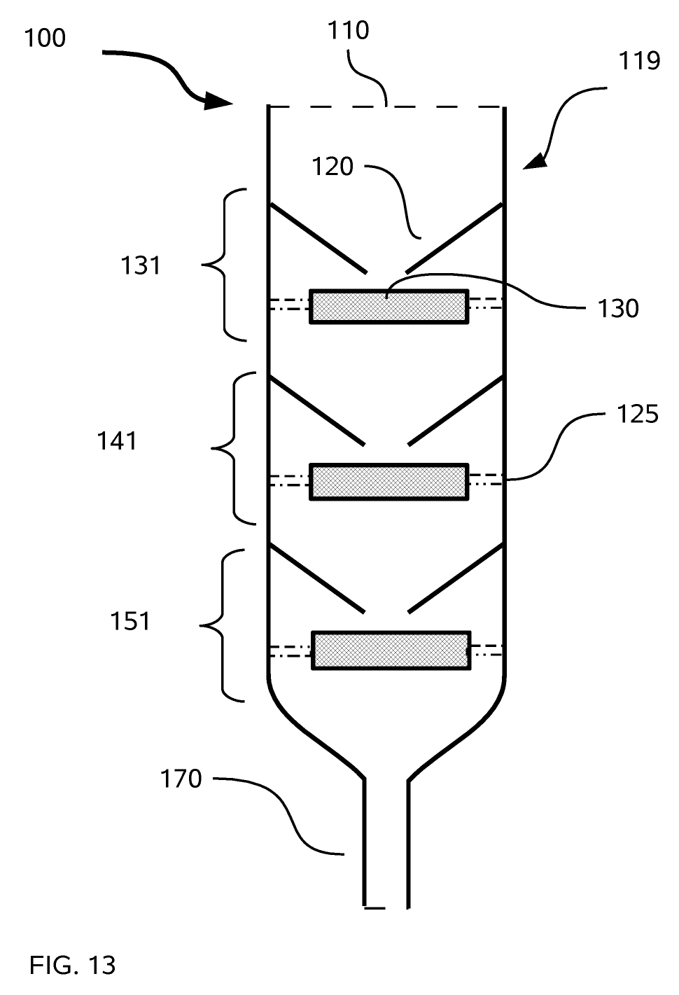

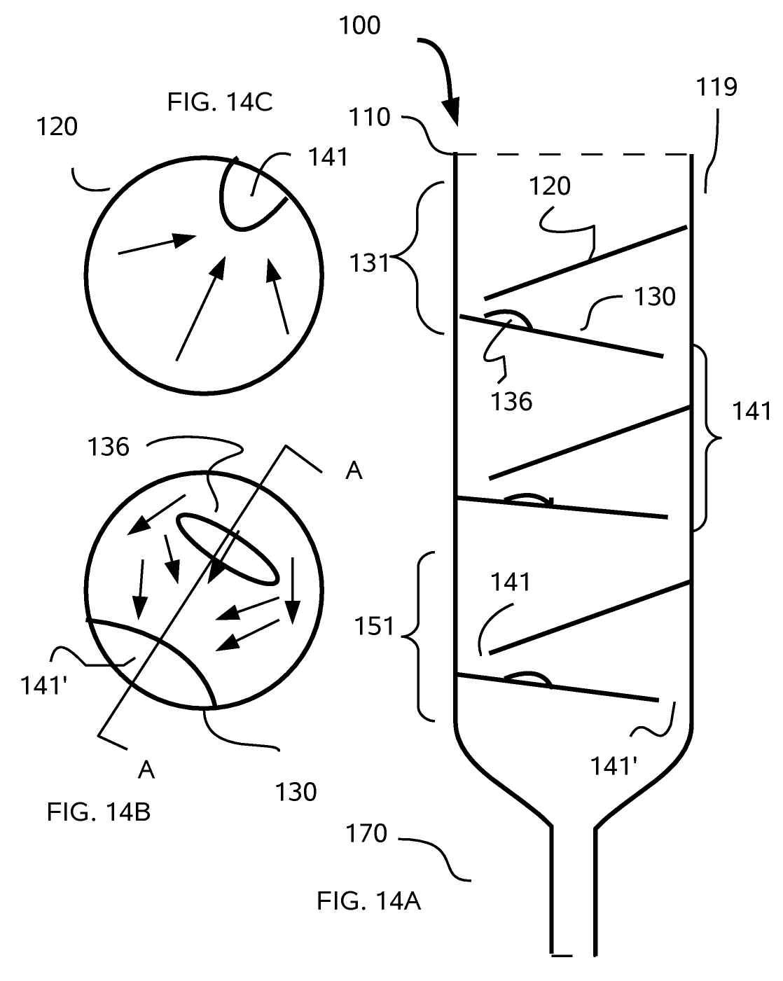

FIG. 9 is a cross-sectional elevation of another embodiment of the invention. Like the alternative embodiment 100 shown in FIG. 10-19, a plurality of discrete aerating chambers of the geometry of FIG. 1-8 is not required, as a plurality of funnels 120 is attached to the a single internal and substantially upright surrounding wall 119. In this embodiment a series of three dispersers 130 are solid inverted cones interspersed between funnels 120 and arranged with the apex pointing upward and disposed below the outlet of each funnel 130. The dispersers 130 are optionally connected to either each other by vertical spacer rod 126, the funnel 120 or the upright sidewall 119 by various alternative spaces 125 also shown in dashed lines in FIG. 13-14. The combination of a funnel 120 and a disperser 130 define an effective aerating flow chamber 131, 141 or 151.

FIG. 10 is a cross-sectional elevation of another embodiment of the invention. In this embodiment, a series of three dispersers 130 are open inverted domes arranged with the apex pointing upward and disposed below the outlet of each funnel 120. The dome can have an elliptical, spherical or compound curvature and are centered within single cylindrical wall 119. The inverted domes are optionally connected to wall 119 by spacers 125 or to the bottom of each funnel 120 by vertical spacers 126.

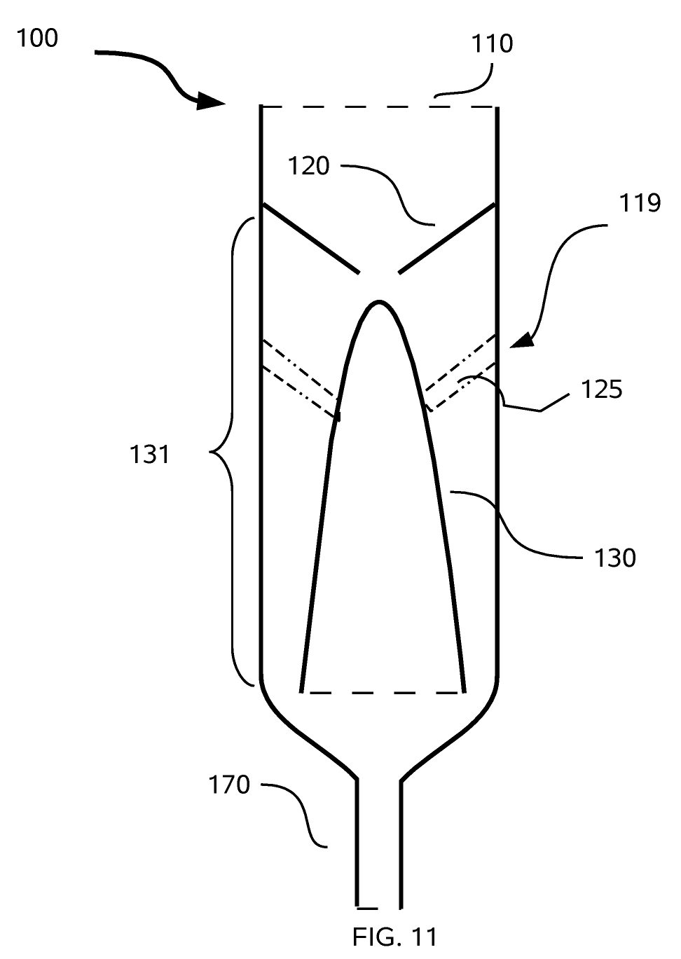

FIG. 11 is a cross-sectional elevation of another embodiment of the invention. In this embodiment a single disperser 130 is an open inverted domes centered within single cylindrical wall 119 and arranged with the apex pointing upward and disposed below the outlet of the first or upper funnel 130. The dome can have an elliptical, spherical or compound curvature. Spacers 125 are shown in broken lines to indicate that they are optionally placed at different locations to connect the dome to the cylindrical wall 119.

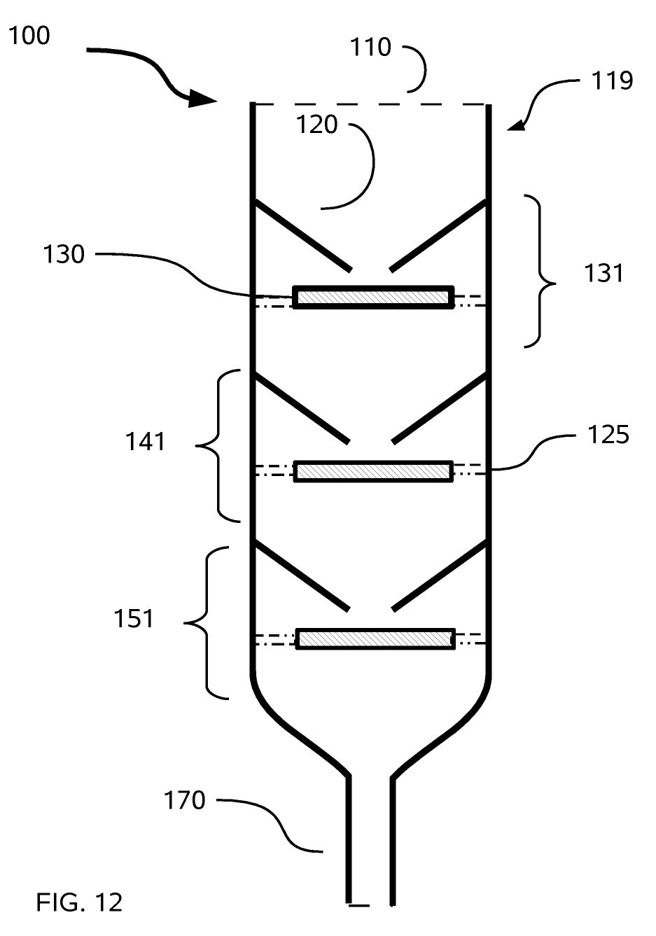

FIG. 12 is a cross-sectional elevation of another embodiment of the invention. In this embodiment a series of three dispersers 130 are flat plates disposed below the outlet of each funnel 120 and centered within single cylindrical wall 119.

FIG. 13 is a cross-sectional elevation of another embodiment of the invention. In this embodiment a series of three dispersers 130 are flat porous plates disposed below the outlet of each funnel 120 and are centered within the single cylindrical wall 119 of device 100.

FIG. 14 is a cross-sectional elevation of another embodiment of the invention. In this embodiment the funnels 120 are the off center portion of a downward facing cone attached to the side of cylindrical wall 119 such that the opening or hole 141 is adjacent wall 119, rather than centered with respect to the central axis of device 100. Below the outlet of each funnel 120 is disperser 130. Each disperser 130 is the offset portion of an upward facing cone attached to the upright inner wall 119 such that the opening 141′ is at the opposite side of the wall 119, rather than centered with respect to the central axis of device 100 so that the drain hole 141 or 141′ from the funnel 120 and disperser 130 respectively are also disposed adjacent wall 119. FIG. 14B is a plan view illustrating the profile of the hole 141′ between the edge of the disperser 130 on the right side of the wall 119 and the 141 between the edge of the funnel 120 and the left side of the wall 119 to ensure a full cascade of wine over each disperser surface 130. It is more preferred that each disperser 130 have an upward bulge 136 below the drain portal of the funnel 120 disposed above it. The bulge 136 is shaped to disperse the fluid over the majority of the disperse element 130. It should be understood that none of the embodiments require that the draining or collecting surface be smooth, but may have bulges, ripples or ribbing and the like to increase or improve the dispersion of wine as well as the exposure to air.

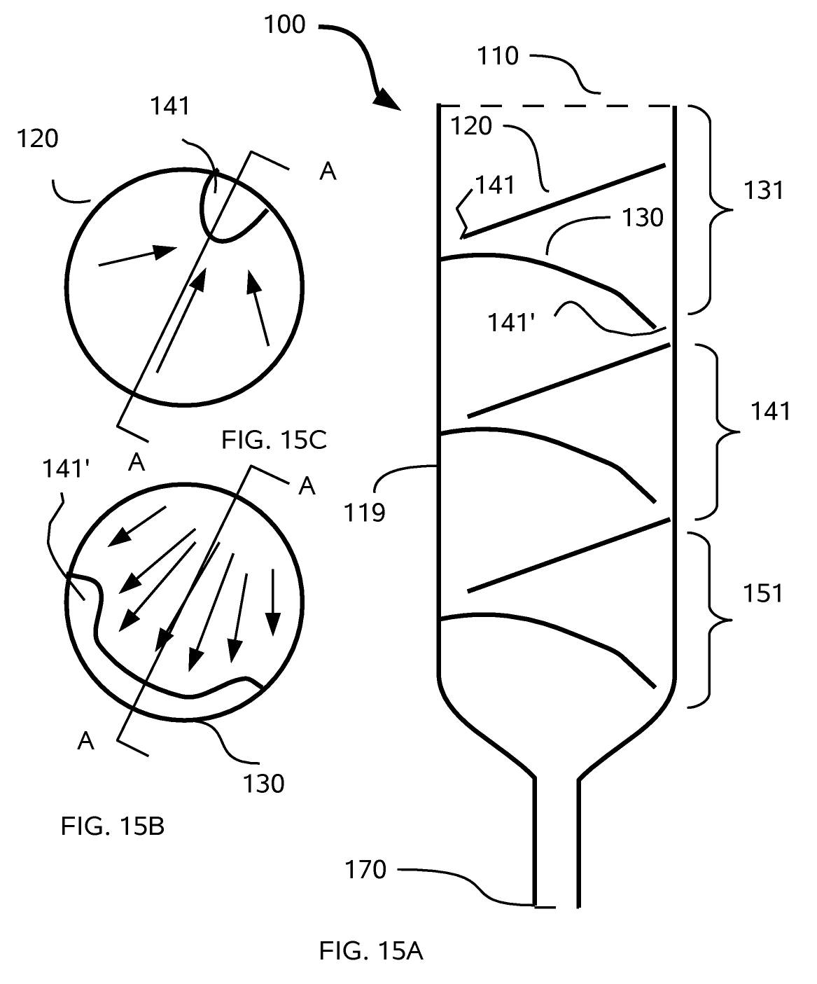

FIG. 15 is a cross-sectional elevation of another embodiment of the invention, the funnels 120 and disperses 130 are arranged as in FIG. 9, however now the disperser 130 is a portion of an off center a dome wherein the hypothetical apex is pointing upward outside the upright cylinder walls 119. The dome can have an elliptical, spherical or compound curvature. Note that the drain hole 141′ from disperser 130 (FIG. 15b) is shaped around a portion of the cylindrical wall 119 to collect wine flowing in the direct of the arrows and then drain in on the portion of the collecting funnels 120 (FIG. 15C) below representing the starting point of the arrows on the collecting funnel 120.

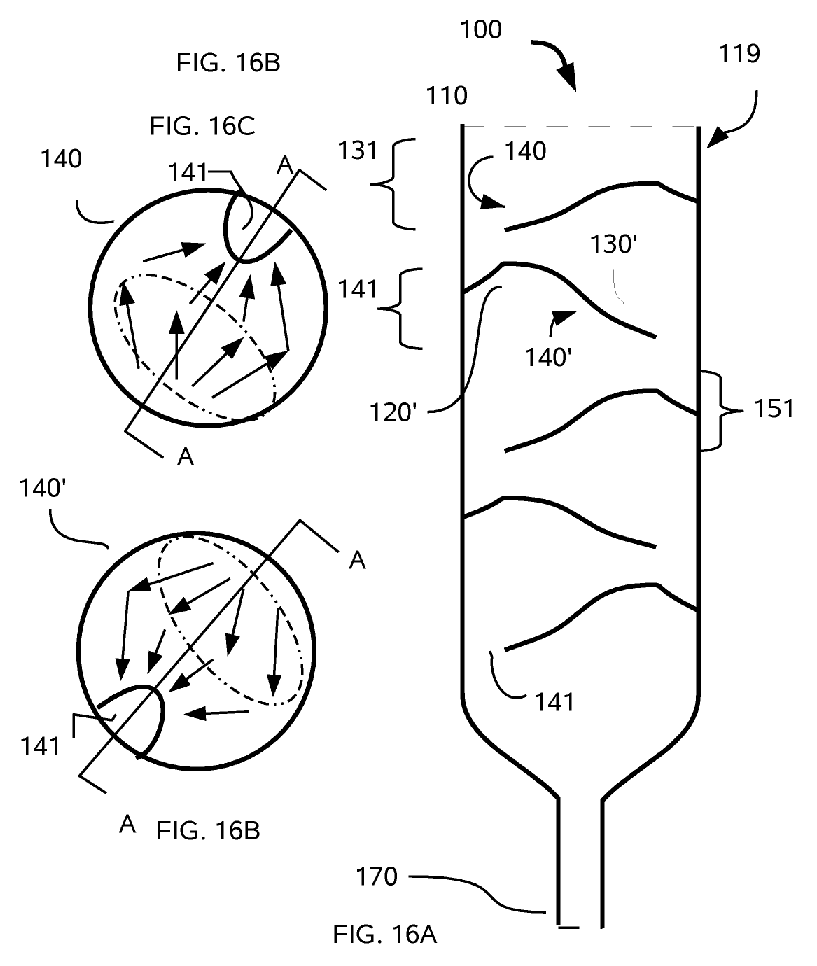

FIG. 16A is a cross-sectional elevation of another embodiment of the invention in which a plurality of draining surfaces 140 and 141′ generally point downward and are attached to the side of the cylindrical wall 119 but are rotated by 180 degrees with respect to the central axis of device 100 to stagger the position of holes 141 and 141′ draining surfaces 140 and 140′ respectively. Each of the draining surfaces 140 and 140′ has a dispersing surface portion 130′ and a collecting or funnel like surface portion 120′ such that is acts likes an aerating flow chamber 131, 41 and 151, etc. in other embodiments. The dispersing surface portion 130′ is generally convex and the collecting surface portion 120′ is generally concave. Plan views, FIG. 16B and FIG. 16C of draining surfaces 140 and 140′ illustrate with arrows the direction of fluid flow across the adjacent draining and collecting surface. The staggered location of holes 141 in each draining surface provides that the hole or outlet 141 of the collecting surface 120′ of the upper draining surface 140 is oriented to drain onto dispersing surface portion 130′ of the lower draining surface 140′.

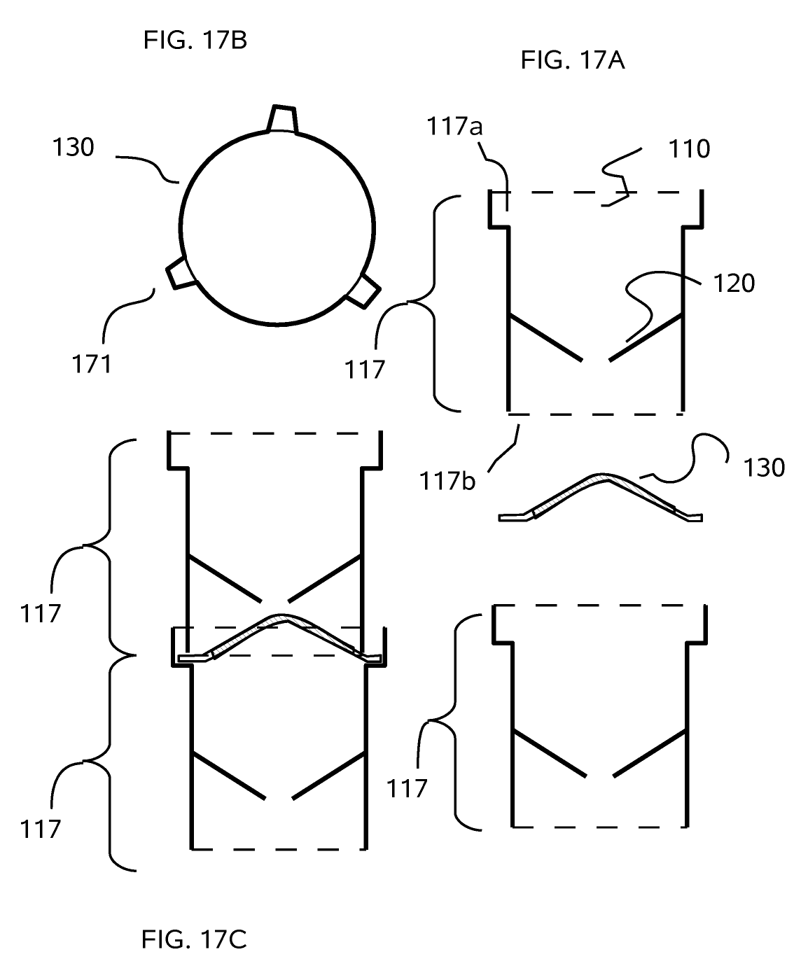

FIG. 17A-C illustrate another embodiment of the invention in which the device comprises multiple tubular components 117 that can be stacked to provide the operative state shown in other embodiments, yet be disassembled for cleaning and storage. Each funnel 120 is disposed with a generally cylindrical element 117. Each cylinder 117 has at least a partially laterally extending upper rim 117a for receiving the separate and detachable disperser 130, as well as resting the lower rim 117b of another funnel and cylinder component on it to ultimately provide multiple aerating flow chamber 131 of the most preferred embodiments. The disperser 130 may take any cross section shape previously described, as well as equivalents thereof, but preferable has 3 or more appendages 171 that extend from the edge to rest on the upper rim portion 117a.

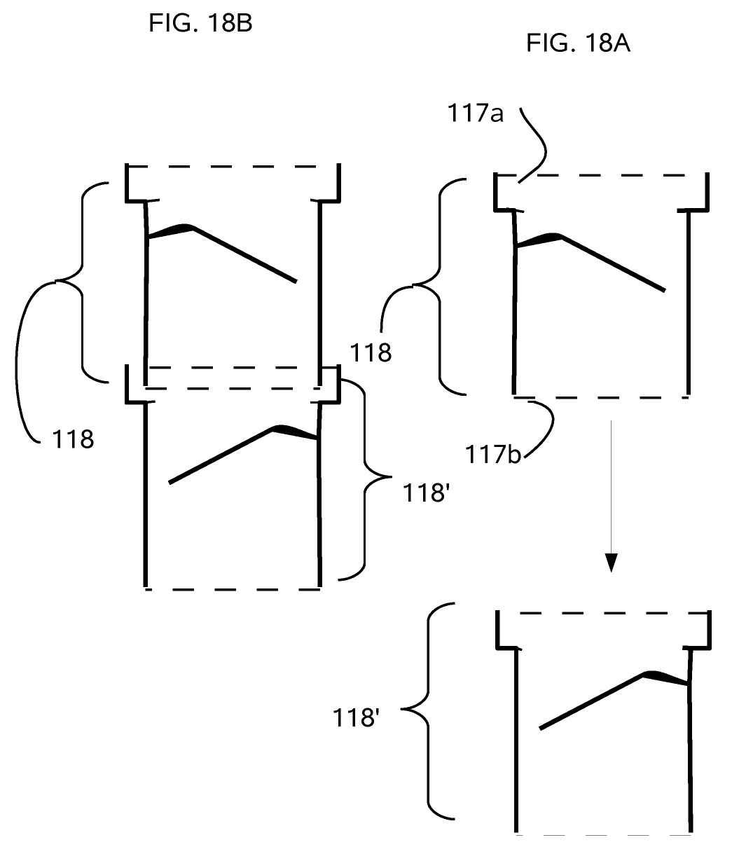

FIG. 18AB are cross sectional elevations of an alternative embodiment where separable cylinder 118 are comparable to that shown in FIG. 16, but have the off center single draining surface element 140 that operates as shown in FIG. 15. In this embodiment, identical cylinders can be stacked, provides they are rotated by 180 degrees as shown to provide for the multiple cascade of wine over each draining surface 140.

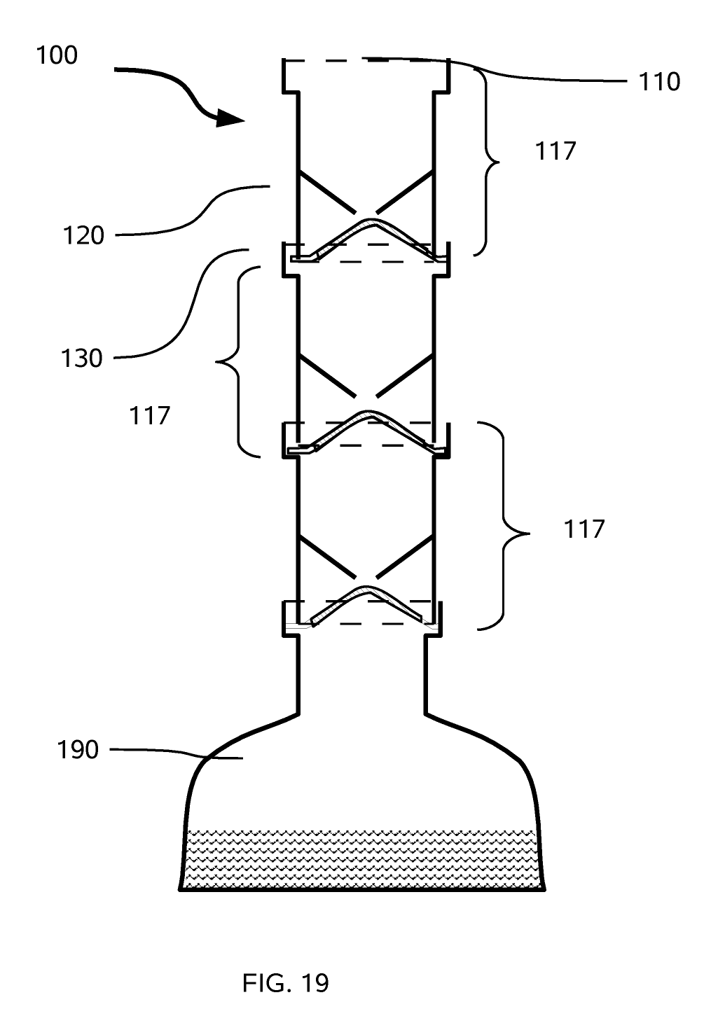

FIG. 19 is a is a cross-sectional elevation of another embodiment of the invention in which the cylinders 117 are stacked with disperser 130 as described with respect to FIG. 17 with the lower rim 117b of the lowest cylinder 117 disposed on the upper rim of the wine receiving vessel 190.

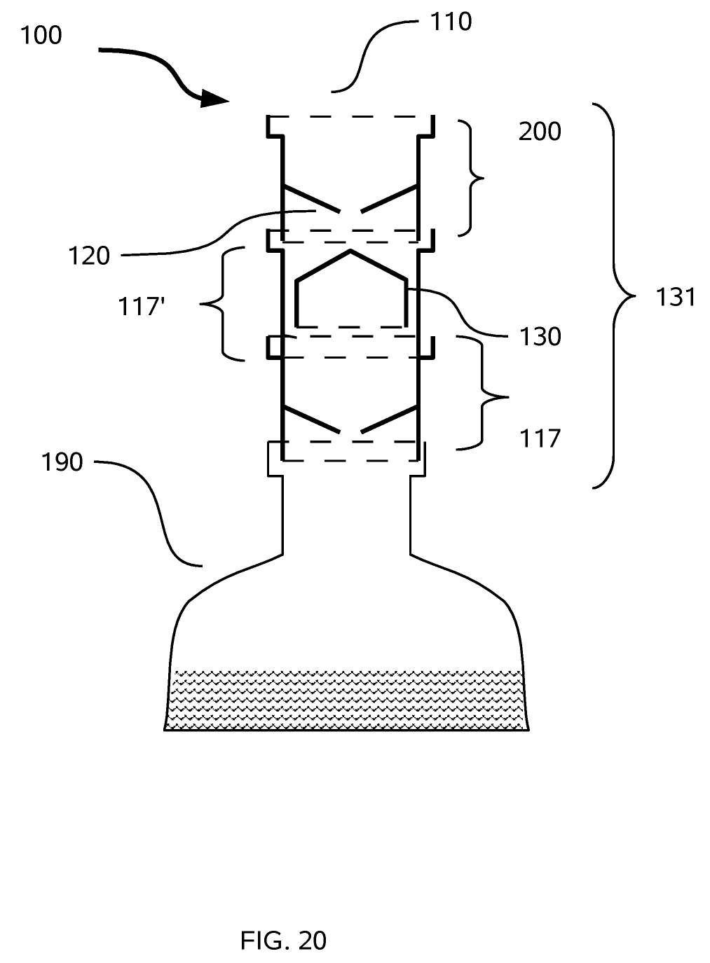

FIG. 20 is a cross-sectional elevation of another embodiment of the invention in which the cylinders 200 and 200′ are similarly alternatively stacked for delivery of wine to a mating serving receptacle 190, to define aerating flow chamber 131. Cylinder 200 has a centrally disposed funnel portion 120, while cylinder 200′ has an inverted cone dispersing element 130 comparable to that shown in FIG. 1-8.

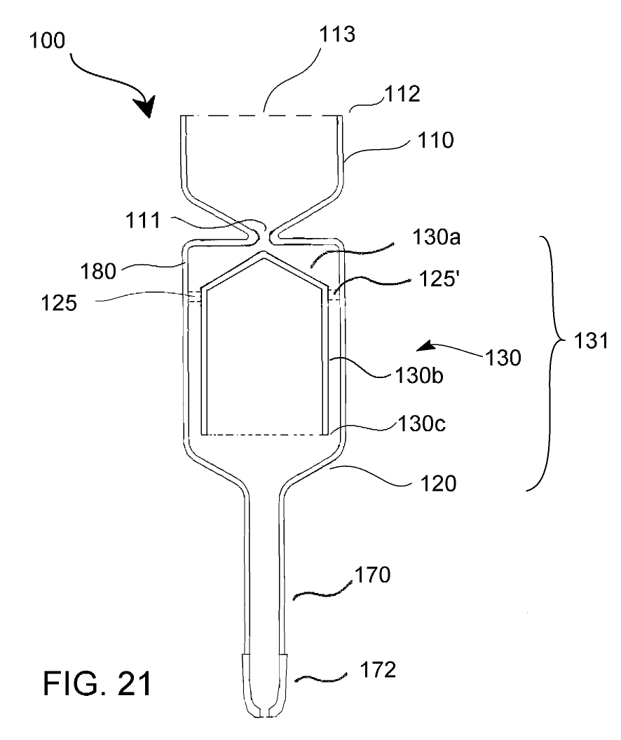

Blind taste testing was used to evaluate select configuration of device 100. The four participants were given five glasses filled with wine that had been marked: Bottle, 1, 2, 3, and 4. They were then asked to compare the taste of each marked glass to that of the glass marked “bottle”, representing un-decanted wine. They were then instructed to grade each marked glass, and record their grades on a questionnaire. The ordering of the samples was randomized for each participant to eliminate the potential for bias from discussions or observing the other participants reactions. There were crackers and water for pallet cleansing. Taster's were asked to differentiate any change from the un-decanted wine on a scale of 1 to 5, with 1 being no change, 2 slight improvement, 3 moderate improvement, 4 significant improvement and 5 greatly improved. Four alternative configurations of device 100 were evaluated, the single aerating flow chamber of FIG. 1, a comparably dimensioned device with dual aerating flow chambers as well as the triple aerating flow chamber device 100 of FIG. 2. Further, a device 100 shown in FIG. 21 with a single tall aerating flow chamber 130 was also evaluated. The disperser surface 130 has an upper cone portion 130a with a height of about 1.5 cm and the height of the descending vertical portion 130b that terminates at lower rim 130c is about 15 cm.

As their where 4 individual tasters, the maximum raw score any configuration could achieve were 20 points. The results below are the sum of the raw scores of the four tasters, divided by 20 and expressed as a percentage. The lowest score, no change, in contrast would be 4/20 or 20%.

| | |
|---|---|
| Triple Chamber: | 81% |
| Double Chamber: | 64% |
| Single Chamber: | 52% |
| Tall Chamber: | 48% |

As the results indicate, the triple aerating flow chamber device was judged as providing the most improvement with a significant margin between it and the alternative embodiments. thus, the use of multiple flow chambers that successively cause the wine to diffuse over a first surface and then collect it again in a funneling portion provide a surprising and unexpected advantage of quickly breathing and improving the taste and olfactory sensations of wine. It should be noted that all embodiments showed some improvement, as even the slightest improvement would result in an average score of 40%.

It should also be appreciated the device and methods of the invention are not limited to the aeration of wine, but may be deployed for the aeration of grape just or grape must to provide oxygen that is beneficial to the fermentation process.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

For example it should be understood that the various embodiments of the device 100 need not be strictly limited to having a cylindrical cross-section but can be oblong, elliptical, rectangular and of any arbitrary shape so long as the function of one or more aerating flow chambers is preserved. Further, it is expected that any combination of the different aerating flow chambers disclosed herein, as would be readily apparent to one of ordinary skill in the art after disclosure of this application, can be mixed and interchanged to form a device with multiple aerating flow chambers.

1. A device for decanting or aerating wine, grape juice or grape must, the device comprising;
a) a fluid receiving upper portion having a lower opening with a smaller diameter than the fluid receiving opening,
b) at least one dispersing surface disposed below the bottom of the lower opening in said fluid receiving upper portion to laterally spread the liquid outward as it flows downward,
c) at least one funneling surface disposed to receive fluid from the dispersing surface, whereby the fluid is collected in a receiving vessel.

2. A device for decanting or aerating wine, grape juice or grape must according to claim 1 wherein the fluid flows over the edge of the dispersing surface to free fall before it reaches the funneling surface.

3. A device for decanting or aerating wine, grape juice or grape must according to claim 1 wherein said fluid receiving upper portion, said at least one dispersing surface and said at least one funnel are connected by an enclosing wall that extends downward from the periphery of said fluid receiving upper portion.

4. A device for decanting or aerating wine, grape juice or grape must according to claim 1 wherein the dispersing surface is convex.

5. A device for decanting wine according to claim 1 wherein the dispersing surface is at least one of planar and porous.

6. A device for decanting or aerating wine, grape juice or grape must according to claim 1 wherein the dispersing surface comprises a first convex portion followed by a second vertical descending portion

7. A device for decanting or aerating wine, grape juice or grape must according to claim 4 wherein the first convex portion is conical and the second descending portion is cylindrical.

8. A device for decanting or aerating wine, grape juice or grape must according to claim 1 wherein said dispersing surface and said funneling surface are concentrically aligned.

9. A device for decanting or aerating wine, grape juice or grape must according to claim 1 further comprising at least one additional pairs of said at least one dispersing surface and said at least one funneling surface, the at least one of said additional pair being disposed to receive the liquid that flows out of the previous funneling surface of said pairs.

10. A device for decanting or aerating wine, grape juice or grape must according to claim 1 containing two or more pairs of said dispersing surfaces and funneling surface in a cascading flow configuration.

11. A device for decanting or aerating wine, grape juice or grape must according to claim 1 wherein said dispersing surface and funneling surface are continuous.

12. A device for decanting or aerating wine, grape juice or grape must according to claim 11 having a plurality of continuous dispersing and funneling surfaces wherein fluid flows off the edge of said funneling surface to free fall onto a lower dispersing surface.

13. A device for decanting or aerating wine, grape juice or grape must according to claim 1 having a plurality of dispersing and funneling surfaces wherein fluid flows off the edge of funneling surface to free fall onto the portion of the lower dispersing surface most distal from the edge thereof.

14. A process for decanting or aerating wine, grape juice or grape must, the process comprising the steps of:
a) pouring the liquid into a first funnel,
b) causing the liquid exiting said first funnel as a stream to spread laterally over at least a portion of a first surface,
c) collecting the liquid as it spills either over and or through the other surface.

15. A process for aerating liquid wine or grape juice according to claim 14 further comprising repeating at least one or more times said step of causing the now collected liquid to spread over at least a portion of a second surface before finally collecting the liquid as it spills either over and or through the other surface.

16. A process for decanting or aerating wine, grape juice or grape must according to claim 14 wherein the other surface is a porous membrane such that fluid flows through and over the edge thereof.

17. The process for decanting or aerating wine, grape juice or grape must according to claim 14 further comprising one or more additional steps of:
a) causing the liquid after being spread laterally to spill onto another dispersing surface one or more additional times after being collected each time.

18. A device for decanting or aerating wine, grape juice or grape must comprising:
a) at least one tubular supporting section having an upper rim and a lower rim,
b) a downward descending funneling surface disposed having an upper portion at least partially attached to the inner wall of said tubular supporting section below the upper rim thereof,
c) at least one dispersing surface to be disposed to receive the output of said downward descending funneling surface, said dispersing surface terminating with an edge that is substantially within the circumference of said tubular supporting section.

19. A device for decanting or aerating wine, grape juice or grape must according to claim 16 and further comprising a second tubular supporting section for supporting said at least one dispersing surface between the bottom of the first tubular section and above the downward descending funneling surface of the second tubular supporting section.

20. A device for decanting or aerating wine, grape juice or grape must according to claim 16 and further comprising a second tubular supporting section wherein the at least one dispensing surface is attached at least partially to the inner wall of said second tubular supporting section so as to be disposed to receive fluid descending from the funnel portion when the supporting the lower rim of the first tubular section on the upper rim thereof.

21. A device for decanting or aerating wine, grape juice or grape must according to claim 16 where the dispersing surface is nested within said tubular supporting section.

22. A device for decanting or aerating wine, grape juice or grape must according to claim 16 wherein the upper rim of said tubular supporting section has a laterally disposed portion for supporting the lower rim of a second tubular supporting section of the dimensions.

23. A device for decanting or aerating wine, grape juice or grape must according to claim 16 wherein the outlet of the downward descending tunneling surface is disposed about the central axis of said tubular section and said tubular section has a circular cross-section.
